(19) United States
(12) Patent Application Publication
(10) Pub. No.: US 2009/0207118 A1
(43) Pub. Date: Aug. 20, 2009

(54) DATA DRIVING UNIT AND LIQUID CRYSTAL DISPLAY

(75) Inventors: Jae Youl Lee, Yongin-si (KR); Jung-Pil Lim, Gwacheon-si (KR); Jong Seon Kim, Seongnam-si (KR); Jang Jin Nam, Yongin-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/372,283

(22) Filed: Feb. 17, 2009

(30) Foreign Application Priority Data
Feb. 15, 2008 (KR) 10-2008-0013858

(51) Int. Cl. G09G 3/36

(52) U.S. Cl. 345/98

(57) ABSTRACT

A data driving unit and a liquid crystal display (LCD) are provided. The data driving unit includes a first buffer, a second buffer, a charge sharing switch connected between an output terminal of the first buffer and an output terminal of the second buffer, and a controller configured to compare a previous line-time data pattern with a current line-time data pattern and generate a control signal for controlling a switching operation of the charge sharing switch according to a comparison result.

### BACKGROUND

The invention relates generally to a data driving unit and a liquid crystal display (LCD) including same. More particularly, the invention relates to a data driving unit having reduced heat generation properties and an LCD including same.

This application claims priority under 35 U.S.C. §119 to Korean Patent Application No. 10-2008-0013858, filed on Feb. 15, 2008, the subject matter of which is hereby incorporated by reference.

Recently, large-size displays, for example, liquid crystal displays (LCDs) have been developed. Large-size LCDs are characterized by high resolution and high picture quality. For instance, conventional high definition (HD) LCDs provide 1366×768 wide XGA (WXGA) resolution and conventional full-HD LCDs provide 1920×1080 widescreen ultra XGA (WUXGA) resolution. As the resolution of LCDs increases, the use of 10 or more digital data bits to represent color gradations is required. Therefore, a data driving unit, (i.e., a source driver supplying a driving current to the liquid crystal panel of a LCD) must support multiple channels and a very fast interface.

In addition, the general increase in liquid panel size requires a commensurate increase in the driving current supplied from the data driving unit to the liquid crystal panel. In turn, this increase in driving current requires an increase in driving power in the data driving unit. However, this increase in driving power also results in the generation of greater heat by the data driving unit. This increased heat generation by the data driving unit has adverse consequences on the long term reliability of the unit, and malfunction of the data driving unit leads to failure of the constituent LCD.

### SUMMARY

Certain embodiments of the invention provide a data driving unit capable of operating with reduced heat generation and a liquid crystal display (LCD) including same.

According to one embodiment, the invention provides a data driving unit including; a first buffer and a second buffer, a charge sharing switch connected between an output terminal of the first buffer and an output terminal of the second buffer, and a controller configured to compare a previous line-time data pattern with a current line-time data pattern and generate a control signal controlling a switching operation of the charge sharing switch according to a comparison result.

In another embodiment, the invention provides a liquid crystal display including; a data driving unit comprising a first buffer, a second buffer, a charge sharing switch connected between an output terminal of the first buffer and an output terminal of the second buffer, and a controller configured to compare a previous line-time data pattern with a current line-time data pattern and generate a control signal for controlling a switching operation of the charge sharing switch according to a comparison result, a gate driving unit configured to output a gate on/off voltage, and a liquid crystal panel configured to display an image, wherein the liquid crystal panel comprising a plurality of gate lines each configured to receive the gate on/off voltage, a plurality of data lines respectively connected with the output terminal of the first buffer and the output terminal of the second buffer, and a plurality of pixels each connected with one of the gate lines and one of the data lines.

### BRIEF DESCRIPTION OF THE DRAWINGS

The above and other features and advantages of the present invention will become more apparent upon a review of certain exemplary embodiments with reference to the attached drawings in which:

FIG. 1 is a block diagram of a liquid crystal display (LCD) according to some embodiments of the present invention;

FIG. 2 is a equivalent circuit diagram of a single pixel in the LCD illustrated in FIG. 1;

FIG. 3 is a block diagram of a data driving unit illustrated in FIG. 2; and

FIG. 4 is a waveform diagram of signals of the data driving unit illustrated in FIG. 3.

### DESCRIPTION OF EMBODIMENTS

The present invention now will be described in some additional detail with reference to the accompanying drawings. The invention may, however, be embodied in many different forms and should not be construed as being limited to only the illustrated embodiments. Rather, the embodiments are provided as teaching examples. In the drawings, the size and relative sizes of various components and elements may be exaggerated for clarity. Throughout the written description and drawings, like reference indicators refer to like or similar elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

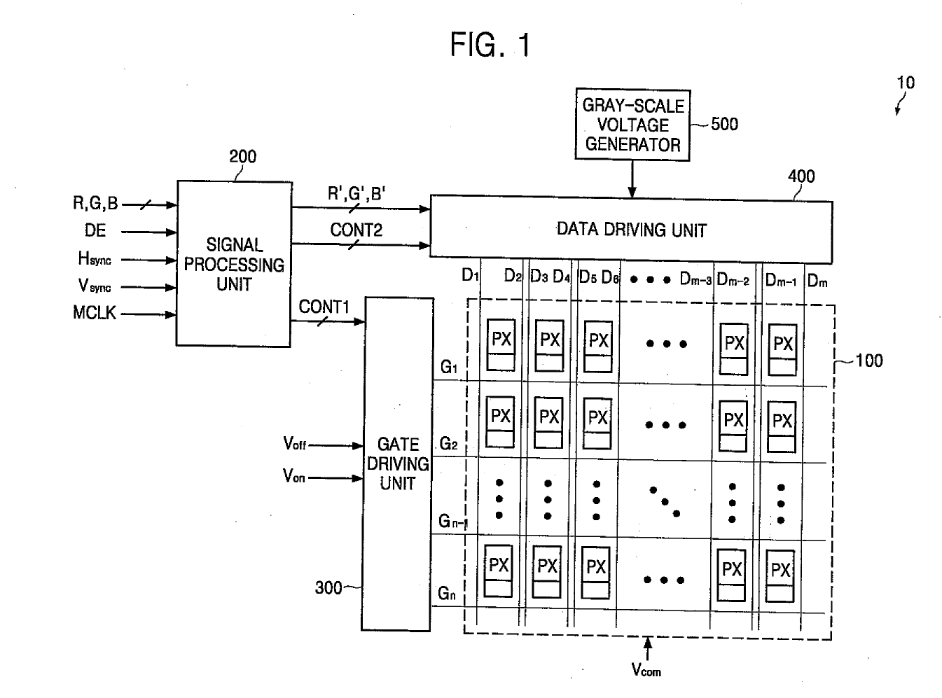

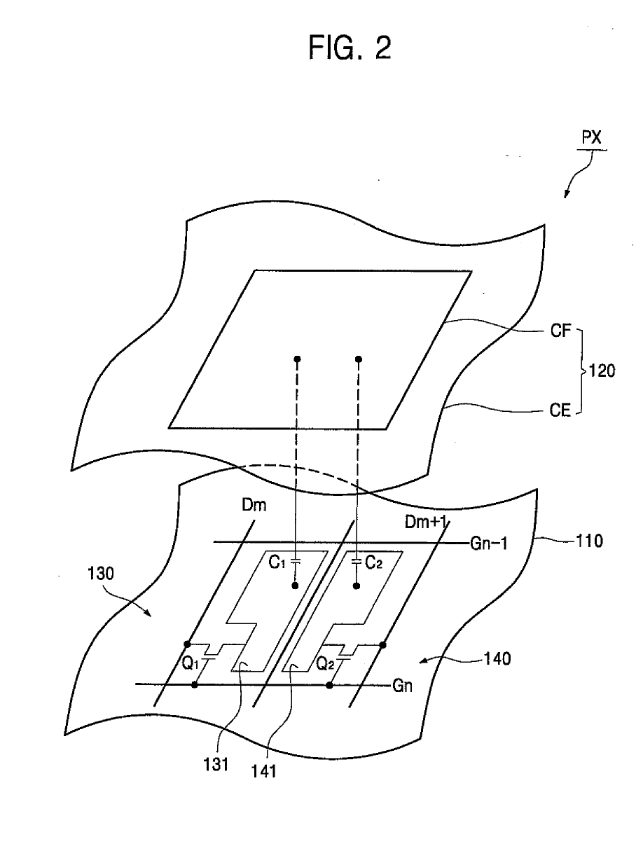

FIG. 1 is a partial block diagram of a liquid crystal display (LCD) 10 according to an embodiment of the invention. FIG. 2 is an equivalent circuit diagram for a single pixel in the LCD 10 illustrated in FIG. 1.

Referring to FIG. 1, the LCD 10 generally includes a liquid crystal panel 100, a signal processing unit 200, a gate driving unit 300, a data driving unit 400, and a gray-scale voltage generator 500. The liquid crystal panel 100 includes a plurality of pixels PX, a plurality of gate lines G₁ through Gₙ, and a plurality of data lines D₁ through Dₘ where “n” and “m” are natural numbers.

The gate signal, e.g., a gate on/off voltage Vₒₙ or V_{off}, from the gate driving unit 300 is applied to each of the gate lines G₁ through Gₙ. The data signal from the data driving unit 400 is applied to each of the data lines D₁ through Dₘ. The gate lines G₁ through Gₙ extend roughly in parallel with one another in a row direction and the data lines D₁ through Dₘ extend roughly in parallel with one another in a column direction. Two of the data lines D₁ through Dₘ are provided for each pixel PX.

Referring to FIG. 2, each pixel PX in the liquid crystal panel 100 includes a first subpixel 130 and a second subpixel 140. The first subpixel 130 and the second subpixel 140 are formed between a first substrate 110 having a first pixel electrode 131 and a second pixel electrode 141 and a second substrate 120 having a common electrode CE and a color filter CF.

In the first substrate 110 are formed a gate line Gₙ extending in the row direction and two data lines Dₘ and Dₘ₊₁ extending in the column direction. The gate line Gₙ and the two data lines Dₘ and Dₘ₊₁ are electrically connected with the first subpixel 130 and the second subpixel 140. A first data signal and a second data signal, which are different from each other, are applied to the first subpixel 130 and the second subpixel 140, respectively. The second data signal may have an opposite phase to the first data signal or may be lower than the first data signal.

The first subpixel 130 includes a first capacitor C₁ which charges the first data signal and a first switch Q₁ which provides the first data signal to the first capacitor C₁ in response to a gate on voltage provided from the gate line Gₙ. The second subpixel 140 includes a second capacitor C₂ which charges the second data signal and a second switch Q₂ which provides the second data signal to the second capacitor C₂ in response to the gate on voltage provided from the gate line Gₙ.

When the first data signal is applied to the first subpixel 130, light provided from a backlight assembly (not shown) is transmitted at a first transmittance corresponding to the first data signal. When the second data signal lower than the first data signal is applied to the second subpixel 140, light provided from the backlight assembly is transmitted at a second transmittance corresponding to the second data signal. Accordingly, an image displayed on the pixel PX has brightness corresponding to an in-between of the first transmittance and the second transmittance. The first pixel electrode 131 and the second pixel electrode 141 are not restricted to the shapes illustrated in FIG. 2 but may be formed in various shapes.

Referring back to FIG. 1, the signal processing unit 200 such as a timing controller receives a plurality of input control signals from an external graphics controller (not shown) and generates a gate control signal CONT1 and a data control signal CONT2 based on the input control signals. The signal processing unit 200 outputs the gate control signal CONT1 to the gate driving unit 300 and the data control signal CONT2 to the data driving unit 400. The input control signals transmitted from the graphics controller to the signal processing unit 200 may include a vertical sync signal V_{sync}, a horizontal sync signal H_{sync}, a main clock signal MCLK, and a data enable signal DE.

The gate control signal CONT1 transmitted from the signal processing unit 200 to the gate driving unit 300 is for controlling the operation of the gate driving unit 300. For instance, the gate control signal CONT1 may include a vertical start signal for starting the operation of the gate driving unit 300, a gate clock signal for determining when to output the gate on voltage Vₒₙ, and an output enable signal for determining a pulse width of the gate on voltage Vₒₙ.

The data control signal CONT2 transmitted from the signal processing unit 200 to the data driving unit 400 is for controlling the operation of the data driving unit 400. For instance, the data control signal CONT2 may include a horizontal start signal for starting the operation of the data driving unit 400 and an output instruction signal for instructing output of two data voltages.

The signal processing unit 200 receives video signals R, G, and B from the graphics controller, processes them to be suitable to the operating conditions of the liquid crystal panel 100, outputs video data signals R′, G′, and B′ to the data driving unit 400. The gate driving unit 300 outputs the gate on/off voltage Vₒₙ or V_{off} input from outside to the gate lines G₁ through Gₙ sequentially in response to the gate control signal CONT1 provided from the signal processing unit 200.

The data driving unit 400 sequentially receives the video data signals R′, G′, and B′ in response to the data control signal CONT2 provided from the signal processing unit 200. Also, the data driving unit 400 selects gray-scale voltages corresponding to the video data signals R′, G′, and B′ from among a plurality of gray-scale voltages provided from the gray-scale voltage generator 500 and provides the selected gray-scale voltages to the data line Dₘ in the first subpixel 130 (FIG. 2) and the data line Dₘ₊₁ in the second subpixel 140 as the first data signal and the second data signal, respectively.

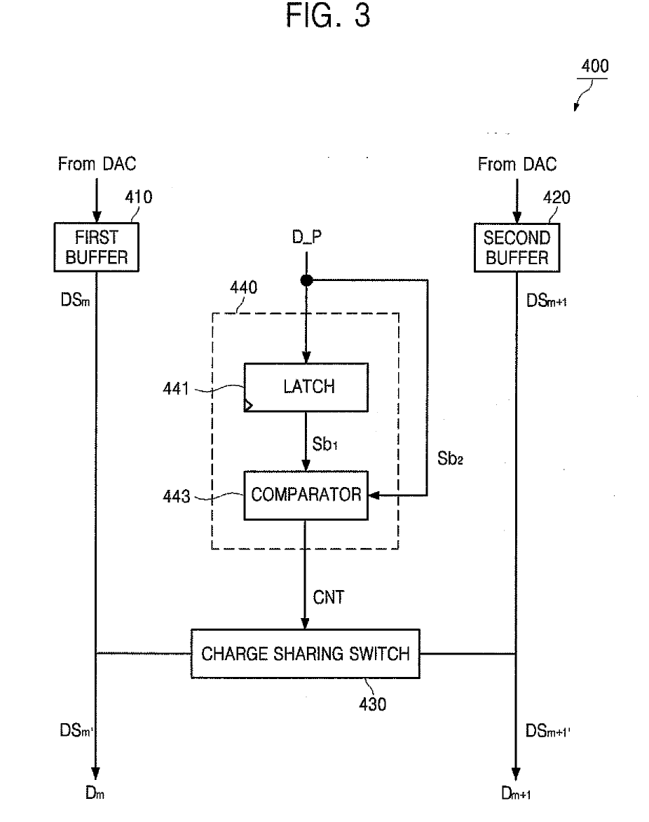

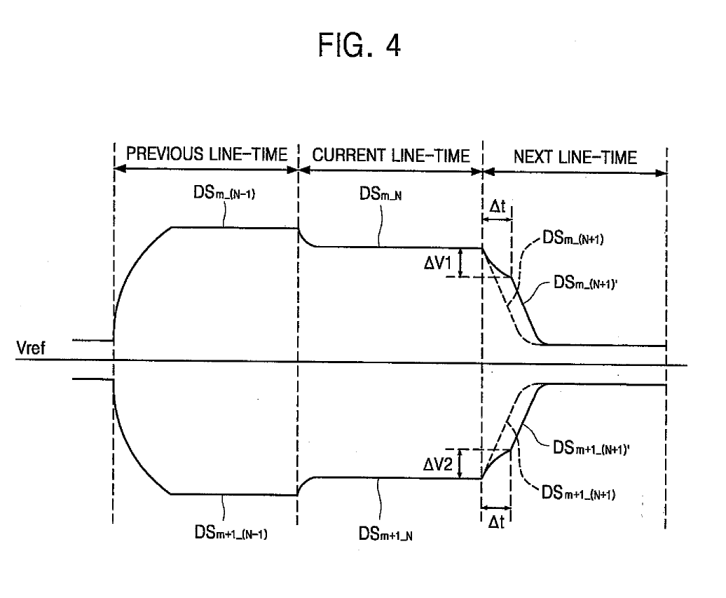

In addition, in order to prevent the amount of heat generation from increasing due to increase in driving power when the size of the liquid crystal panel 100 increases, the data driving unit 400 may include a charge sharing switch that performs charge sharing. For example, “charge sharing” may include control steps to pre-charge or pre-discharge the first data signal and/or the second data signal. A constituent controller may be used to control charge sharing by means of a (e.g.,) a selectively operated switch. An exemplary charge sharing switch and corresponding controller will be described in some additional detail with reference to FIGS. 3 and 4.

The gray-scale voltage generator 500 includes a plurality of resistors (not shown) connected in series between a node (not shown) to which a driving voltage is applied and a ground (not shown) to divide the voltage level of the driving voltage and generate a plurality of gray-scale voltages. The gray-scale voltage generator 500 is not restricted to the above-described internal structure but may be implemented in various forms.

Hereinafter, the data driving unit 400 according to certain embodiments of the invention will be described in some additional detail with reference to FIGS. 3 and 4. FIG. 3 is a block diagram of an exemplary data driving unit 400 capable of use within the context of FIG. 2. FIG. 4 is a corresponding waveform diagram illustrating signals associated with the data driving unit 400 of FIG. 3.

Referring to FIG. 3, the data driving unit 400 includes a pair of output units, i.e., a first buffer 410 and a second buffer 420, a charge sharing switch 430, and a controller 440. The pair of output units may be implemented by a plurality of buffers, as illustrated in FIG. 3, or may be implemented by an amplifier.

The first buffer 410 outputs a signal provided from outside, for example, a digital-to-analog converter (DAC) (not shown), to the data line Dₘ illustrated in FIG. 2 as an output signal DSₘ of the first buffer 410, for example, the first data signal. The second buffer 420 outputs a signal provided from the DAC to the data line Dₘ₊₁ as an output signal DSₘ₊₁ of the second buffer 420, for example, the second data signal. Each of the signals respectively provided from the DAC to the first buffer 410 and the second buffer 420 may be a signal obtained by converting a digital signal, e.g., a data pattern D_P, transmitted from the signal processing unit 200 (FIG. 1) to the DAC included in the data driving unit 400, into an analog signal corresponding to a gray-scale voltage. The data pattern D_P may be N-bit data, where N is a natural number, (e.g., N=10).

The charge sharing switch 430 may be connected between an output terminal of the first buffer 410 and an output terminal of the second buffer 420. The charge sharing switch 430 performs a switching operation in response to a control signal CNT provided from outside, for example, the controller 440. When the charge sharing switch 430 performs the switching operation, the first data signal DSₘ and the second data signal DSₘ₊₁ are subjected to charge sharing, for example, they may be pre-charged or pre-discharged to a predetermined level. The charge sharing switch 430 may be implemented by a P-channel metal-oxide-semiconductor field effect transistor (PMOSFET) or N-channel metal-oxide-semiconductor field effect transistor (NMOSFET) switching element.

The controller 440 may include a latch 441 and a comparator 443. The latch 441 may receive and store at least one upper bit including a most significant bit (MSB) of a data pattern D_P provided from outside. For instance, the latch 441 may receive a data pattern D_P corresponding to the first data signal DSₘ input to the first buffer 410 and store at least one upper bit, for example, two upper bits Sb1 including the MSB of the data pattern D_P. In addition, the latch 441 may receive a data pattern D_P corresponding to the second data signal DSₘ₊₁ input to the second buffer 420 and store at least one upper bit, for example, two upper bits Sb1 including the MSB of the data pattern D_P. Here, the latch 441 may receive the data pattern D_P corresponding to the first data signal DSₘ or the data pattern D_P corresponding to the second data signal DSₘ₊₁ and store at least one upper bit Sb1 of the received data pattern D_P. The latch 441 may be implemented by a flip-flop, for example, a D flip-flop.

The comparator 443 compares the at least one upper bit Sb1 of the data pattern D_P stored in the latch 441 with at least one upper bit Sb2 of another data pattern D_P provided from outside and outputs the control signal CNT according to a comparison result. The control signal CNT may be output at a different level, (e.g., a logically “high” level or a logically “low” level). The control signal CNT may control the switching operation, (e.g., turn-ON or turn-OFF, of the charge sharing switch 430).

When the comparator 443 outputs a high control signal CNT according to the comparison result, the charge sharing switch 430 may be turned ON in response to the high control signal CNT. Then, the charge sharing switch 430 may connect the output terminal of the first buffer 41 0 with the output terminal of the second buffer 420 and pre-discharge or pre-charge the output signal DSₘ of the first buffer 410 and the output signal DSₘ₊₁ of the second buffer 420, e.g., the first data signal DSₘ and the second data signal DSₘ₊₁ corresponding to data patterns D_P input to the latch 441. Accordingly, the first buffer 410 and the second buffer 420 may output a pre-discharged or pre-charged first data signal DS_{m′} and a pre-discharged or pre-charged second data signal DS_{m+1′}, respectively.

In other words, the first buffer 410 and the second buffer 420 are driven the moment the first data signal DSₘ and the second data signal DSₘ₊₁ have been pre-discharged or pre-charged by the charge sharing switch 430, and therefore, driving power for the first buffer 410 and the second buffer 420 can be reduced. As a result, the amount of heat generated by the data driving unit 400 may be reduced. The comparator 443 may be implemented using a logic gate, (e.g., a NAND gate or a NOR gate).

Hereinafter, the operation of the data driving unit 400 will be described in some additional detail with reference to FIGS. 1 through 4. Firstly, the operation of the data driving unit 400 during a previous line-time of the LCD 10, for example, an (N−1) line-time (where N denotes a current line-time of the LCD 10) while a plurality of switches Q₁ and Q₂ connected with the first gate line G₁ are turned on when the gate on voltage Vₒₙ is applied from the gate driving unit 300 to the first gate line G₁ of the liquid crystal panel 100, will be described.

During the previous line-time of the LCD 100, the first buffer 410 of the data driving unit 400 outputs an (N−1) line-time first output signal DSₘ_{_{—}}_{(N-1)} to the first subpixel 130 connected with the first gate line G₁ and the first data line D₁ and the second buffer 420 of the data driving unit 400 outputs an (N−1) line-time second output signal DSₘ₊₁_{_{—}}_{(N-1)} to the second subpixel 140 connected with the first gate line G₁ and the second data line D₂. At this time, the (N−1) line-time first output signal DSₘ_{_{—}}_{(N-1)} and the (N−1) line-time second output signal DSₘ₊₁_{_{—}}_{(N-1)} may have opposite phases to each other with respect to a reference voltage signal Vref.

Meanwhile, the latch 441 of the controller 440 in the data driving unit 400 receives a data pattern D_P corresponding to the (N−1) line-time first output signal DSₘ_{_{—}}_{(N-1)} output from the first buffer 410 or a data pattern D_P corresponding to the (N−1) line-time second output signal DSₘ₊₁_{_{—}}_{(N-1)} output from the second buffer 420. The latch 441 stores upper bits of the received data pattern D_P, for example, two upper bits Sb1 including the MSB of the data pattern D_P. In the illustrated embodiments of the invention, it is assumed that the latch 441 receives the data pattern D_P corresponding to the (N−1) line-time first output signal DSₘ_{_{—}}_{(N-1)} output from the first buffer 410 and stores the two upper bits Sb1 including the MSB of the data pattern D_P.

Secondly, the operation of the data driving unit 400 during a current line-time of the LCD 10, for example, an N line-time while a plurality of switches Q₁ and Q₂ connected with the second gate line G₂ are turned on when the gate on voltage Vₒₙ is applied from the gate driving unit 300 to the second gate line G₂ of the liquid crystal panel 100, will be described. During the current line-time of the LCD 10, the first buffer 410 of the data driving unit 400 outputs an N line-time first output signal DSₘ_{_{—}}_{N} to the first subpixel 130 connected with the second gate line G₂ and the first data line D₁ and the second buffer 420 of the data driving unit 400 outputs a N line-time second output signal DSₘ₊₁_{_{—}}_{N} to the second subpixel 140 connected with the second gate line G₂ and the second data line D₂. As described above, the N line-time first output signal DSₘ_{_{—}}_{N} and the N line-time second output signal DSₘ₊₁_{_{—}}_{N} may have opposite phases with respect to the reference voltage signal Vref.

Meanwhile, the latch 441 of the controller 440 in the data driving unit 400 outputs to the comparator 443 the two upper bits Sb1 including the MSB of the stored data pattern D_P, i.e., the data pattern D_P corresponding to the (N−1) line-time first output signal DSₘ_{_{—}}_{(N-1)} output from the first buffer 410 during the (N−1) line-time of the LCD 10, in response to a predetermined clock signal provided from outside. The latch 441 also receives a data pattern D_P corresponding to the N line-time first output signal DSₘ_{_{—}}_{N} output from the first buffer 410 and stores upper bits of the received data pattern D_P, for example, two upper bits including the MSB of the data pattern D_P.

The comparator 443 compares the two upper bits Sb1 including the MSB of the data pattern D_P corresponding to the (N−1) line-time first output signal DSₘ_{_{—}}_{(N-1)} received from the first buffer 410 during the (N−1) line-time of the LCD 10 with two upper bits Sb2 including the MSB of the data pattern D_P corresponding to the N line-time first output signal DSₘ_{_{—}}_{N} or the MSB of a data pattern D_P corresponding to the N line-time second output signal DSₘ₊₁_{_{—}}_{N}. In the illustrated embodiments of the invention, the comparator 443 compares the two upper bits Sb1 including the MSB of the data pattern D_P corresponding to the (N−1) line-time first output signal DSₘ_{_{—}}_{(N-1)} with the two upper bits Sb2 including the MSB of the data pattern D_P corresponding to the N line-time first output signal DSₘ_{_{—}}_{N}.

Thereafter, the comparator 443 outputs the control signal CNT according to a comparison result. For instance, when the two upper bits Sb1 of the data pattern D_P provided from the latch 441 to the comparator 443 are “11” and the two upper bits Sb2 of the data pattern D_P corresponding to the N line-time first output signal DSₘ_{_{—}}_{N} are slightly less than the two upper bits Sb1 provided from the latch 441, for example, “10”, the comparator 443 may output a low control signal CNT since the MSB of the (N−1) line-time data pattern D_P is substantially the same as that of the N line-time data pattern D_P.

In response to the low control signal CNT output from the comparator 443, the charge sharing switch 430 is turned OFF and does not perform charge sharing, for example, pre-charge or pre-discharge, with respect to the output signal DSₘ_{_{—}}_{N} of the first buffer 410 and the output signal DSₘ₊₁_{_{—}}_{N} of the second buffer 420 during the N line-time of the LCD 10. Accordingly, during the N line-time, the data driving unit 400 provides the N line-time first output signal DSₘ_{_{—}}_{N} and the N line-time second output signal DSₘ₊₁_{_{—}}_{N} as data signals to the first subpixel 130 connected with the second gate line G₂ and the first data line D₁ and the second subpixel 140 connected with the second gate line G₂ and the second data line D₂, respectively.

Thirdly, the operation of the data driving unit 400 during a next line-time of the LCD 10, for example, an (N+1) line-time while a plurality of switches Q₁ and Q₂ connected with the third gate line G₃ are turned on when the gate on voltage Vₒₙ is applied from the gate driving unit 300 to the third gate line G₃ of the liquid crystal panel 100, will be described. During the next line-time of the LCD 10, the first buffer 410 of the data driving unit 400 outputs an (N+1) line-time first output signal DSₘ_{_{—}}_{N+1} to the first subpixel 130 connected with the third gate line G₃ and the first data line D₁ and the second buffer 420 of the data driving unit 400 outputs a (N+1) line-time second output signal DSₘ₊₁_{_{—}}_{N+1} to the second subpixel 140 connected with the third gate line G₃ and the second data line D₂.

Meanwhile, the latch 441 of the controller 440 in the data driving unit 400 outputs to the comparator 443 two upper bits Sb1 including the MSB of the stored data pattern D_P, i.e., the data pattern D_P corresponding to the N line-time first output signal DSₘ_{_{—}}_{N} output from the first buffer 410 during the N line-time of the LCD 10, in response to a predetermined clock signal provided from outside. The latch 441 also receives a data pattern D_P corresponding to the (N+1) line-time first output signal DSₘ_{_{—}}_{(N+1)} output from the first buffer 410 and stores upper bits of the received data pattern D_P, for example, two upper bits including the MSB of the data pattern D_P, in response to the predetermined clock.

The comparator 443 compares the two upper bits Sb1 including the MSB of the data pattern D_P corresponding to the N line-time first output signal DSₘ_{_{—}}_{N} received from the latch 441 with two upper bits Sb2 including the MSB of the data pattern D_P corresponding to the (N+1) line-time first output signal DSₘ_{_{—}}_{(N+1)}. Thereafter, the comparator 443 outputs the control signal CNT according to a comparison result. For instance, when the two upper bits Sb1 of the data pattern D_P provided from the latch 441 to the comparator 443 are at the high level, for example, “10”, and the two upper bits Sb2 of the data pattern D_P corresponding to the (N+1) line-time first output signal DSₘ_{_{—}}_{(N+1)} are low, for example, “00”, the comparator 443 may output a high control signal CNT since the MSB of the N line-time data pattern D_P is different from that of the (N+1) line-time data pattern D_P.

In other words, the comparator 443 outputs the high control signal CNT to control the operation of the charge sharing switch 430 when the data pattern D_P corresponding to the (N+1) line-time first output signal DSₘ_{_{—}}_{(N+}1) is greatly lower than the data pattern D_P provided from the latch 441. This means that heat generated in the data driving unit 400 may be generated mostly from the first buffer 410 or the second buffer 420. By the way, the output signal of the first buffer 410 and the output signal of the second buffer 420 may have opposite phases to each other with respect to the reference voltage signal Vref.

At this time, when the output signal DSₘ_{_{—}}_{(N+1)} of the first buffer 410 during the (N+1) line-time is lower than the output signal DSₘ_{_{—}}_{N} of the first buffer 410 during the N line-time, most of heat is generated from the first buffer 410 and the second buffer 420. Accordingly, the comparator 443 may compare the data pattern D_P corresponding to the (N+1) line-time first output signal DSₘ_{_{—}}_{(N+1)} with the data pattern D_P corresponding to the N line-time first output signal DSₘ_{_{—}}_{N} and output the high control signal CNT when the data pattern D_P decreases so as to control the operation of the charge sharing switch 430.

In response to the high control signal CNT output from the comparator 443, the charge sharing switch 430 is turned ON and performs charge sharing with respect to the output signal DSₘ_{_{—}}_{(N+1)} of the first buffer 410 and the output signal DSₘ₊₁_{_{—}}_{(N+1)} of the second buffer 420 during the (N+1) line-time of the LCD 10. In some additional detail, the charge sharing switch 430 is turned ON in response to the high control signal CNT and pre-discharges the (N+1) line-time first output signal DSₘ_{_{—}}_{(N+1)} of the first buffer 410 for a predetermined period of time Δt to decrease it by a first level ΔV1 during the (N+1) line-time. In addition, the charge sharing switch 430 turned ON in response to the high control signal CNT pre-charges the (N+1) line-time second output signal DSₘ₊₁_{_{—}}_{(N+1)} of the second buffer 420 for the predetermined period of time Δt to increase it by a second level ΔV2 during the (N+1) line-time.

Accordingly, during the (N+1) line-time, the data driving unit 400 outputs as a data signal a first output signal DSₘ_{_{—}}_{(N+1)′} resulting from pre-discharging the output signal DSₘ_{_{—}}_{(N+1)} of the first buffer 410 by the first level ΔV1 to the first subpixel 130 connected with the third gate line G₃ and the first data line D₁ in the liquid crystal panel 100 and outputs as another data signal a second output signal DSₘ₊₁_{_{—}}_{(N+1)′} resulting from pre-charging the output signal DSₘ₊₁_{_{—}}_{(N+1)} of the second buffer 420 by the second level ΔV2 to the second subpixel 140 connected with the third gate line G₃ and the second data line D₂ in the liquid crystal panel 100.

In other words, the first buffer 410 of the data driving unit 400 is driven from the moment it has been pre-discharged by the first level ΔV1 by the charge sharing switch 430 and outputs the first output signal DSₘ_{_{—}}_{(N+1)′}, and the second buffer 420 of the data driving unit 400 is driven from the moment it has been pre-charged by the second level ΔV2 by the charge sharing switch 430 and outputs the second output signal DSₘ₊₁_{_{—}}_{(N+1)′}, so that the driving power for the first buffer 410 and the second buffer 420 is decreased. As a result, the amount of heat generated in the data driving unit 400 is also decreased.

As described above, a data driving unit according to embodiments of the invention compares the patterns of data signals provided to adjacent pixels, for example, a plurality of pixels respectively connected with adjacent gate lines, during different line-times in an LCD and selectively performs charge sharing with respect to the data signals, thereby decreasing driving power and reducing the amount of heat generated.

According to embodiments of the invention, data signals are selectively pre-charged or pre-discharged in a data driving unit, so that the driving power and the amount of heat generation in the data driving unit are decreased. As a result, the likelihood of LCD malfunction may be reduced.

While the present invention has been particularly shown and described with reference to exemplary embodiments thereof, it will be understood by those of ordinary skill in the art that various changes in forms and details may be made therein without departing from the scope of the present invention as defined by the following claims.

What is claimed is:

1. A data driving unit comprising:
a first buffer and a second buffer;
a charge sharing switch connected between an output terminal of the first buffer and an output terminal of the second buffer; and
a controller configured to compare a previous line-time data pattern with a current line-time data pattern and generate a control signal controlling a switching operation of the charge sharing switch according to a comparison result.

2. The data driving unit of claim 1, wherein the charge sharing switch pre-charges or pre-discharges an output signal of the first buffer corresponding to the current line-time data pattern and an output signal of the second buffer in response to the control signal.

3. The data driving unit of claim 1, wherein the controller comprises:
a latch configured to store at least one upper bit of the previous line-time data pattern; and
a comparator configured to compare at least one upper bit of the current line-time data pattern with the at least one upper bit of the previous line-time data pattern stored in the latch and output the control signal according to a comparison result.

4. The data driving unit of claim 3, wherein, when the at least one upper bit of the previous line-time data pattern is different from the at least one upper bit of the current line-time data pattern, the comparator outputs the control signal at a first level and the charge sharing switch connects the output terminal of the first buffer with the output terminal of the second buffer in response to the first-level control signal.

5. The data driving unit of claim 1, wherein the charge sharing switch is a P-channel metal-oxide semiconductor (PMOS) or an N-channel metal-oxide semiconductor (NMOS).

6. A liquid crystal display comprising:
a data driving unit comprising a first buffer, a second buffer, a charge sharing switch connected between an output terminal of the first buffer and an output terminal of the second buffer, and a controller configured to compare a previous line-time data pattern with a current line-time data pattern and generate a control signal for controlling a switching operation of the charge sharing switch according to a comparison result;
a gate driving unit configured to output a gate on/off voltage; and
a liquid crystal panel configured to display an image,
wherein the liquid crystal panel comprising a plurality of gate lines each configured to receive the gate on/off voltage, a plurality of data lines respectively connected with the output terminal of the first buffer and the output terminal of the second buffer, and a plurality of pixels each connected with one of the gate lines and one of the data lines.

7. The liquid crystal display of claim 6, wherein the charge sharing switch pre-charges or pre-discharges an output signal of the first buffer corresponding to the current line-time data pattern and an output signal of the second buffer in response to the control signal.

8. The liquid crystal display of claim 6, wherein the controller comprises:
a latch configured to store at least one upper bit of the previous line-time data pattern; and
a comparator configured to compare at least one upper bit of the current line-time data pattern with the at least one upper bit of the previous line-time data pattern stored in the latch and output the control signal according to a comparison result.

9. The liquid crystal display of claim 8, wherein, when the at least one upper bit of the previous line-time data pattern is different from the at least one upper bit of the current line-time data pattern, the comparator outputs the control signal at a first level and the charge sharing switch connects the output terminal of the first buffer with the output terminal of the second buffer in response to the first-level control signal.

10. The liquid crystal display of claim 6, wherein the charge sharing switch is a P-channel metal-oxide semiconductor (PMOS) or an N-channel metal-oxide semiconductor (NMOS).
